(19) United States
(12) Patent Application Publication
(10) Pub. No.: US 2013/0262215 A1
(43) Pub. Date: Oct. 3, 2013

(54) MANAGEMENT OF GIFT CARDS AND LOYALTY PROGRAMS USING SOCIAL NETWORKS

(71) Applicant: Daleyne GUAY, Boucherville (CA)

(72) Inventor: Daleyne GUAY, Boucherville (CA)

(73) Assignee: FANBOX INC., Boucherville (CA)

(21) Appl. No.: 13/431,025

(22) Filed: Mar. 27, 2012

(51) Int. Cl. G06Q 30/02

(52) U.S. Cl. 705/14.36; 705/14.1

(57) ABSTRACT

The present relates to a method and system for managing a purchase incentive program using social networks. For doing so, the present method and system receives a purchase incentive program management request, the purchase incentive program management request being generated by at least one interaction of a customer with a social network. The method and system processes the purchase incentive program management request, in relation with a profile of the customer. The purchase incentive program may consist of a gift card program, or a loyalty program. The management of the purchase incentive program using the social network includes: registration to the purchase incentive program, interrogation of the balance of the purchase incentive program, transmission of a social network profile, and generation of a targeted promotion.

### TECHNICAL FIELD

The present disclosure relates to the field of management of purchase incentive programs; and more particularly to the usage of social networks as a new channel to perform management of gift cards and loyalty programs.

### BACKGROUND

Purchase incentive programs, such as gift cards and loyalty programs, have been used for a long time. These programs encourage customers to buy more products and services, from one or a group of merchants. They also encourage customers to remain loyal to one or a group or merchants; by selecting a merchant affiliated to a loyalty program, rather than a non-affiliated merchant.

The management of purchase incentive programs is complex. It includes the processing and recording of a large number of transactions. It also includes the management of the interactions with the customers affiliated to the purchase incentive program.

The management of the interactions with the customers affiliated to a purchase incentive program may be facilitated by the usage of a centralized web site. Some of the interactions are performed via the centralized web site. Other interactions (like notifications) may be performed by the usage of email, or short message services (SMS).

However, nowadays, most persons are increasingly relying on the usage of dedicated web sites, emails, SMS, etc, to manage many aspects of their personal, professional, and administrative life. And it becomes increasingly complex and time consuming for a person, to manage all these interactions related to the various aspects of their digital life. Thus, managing the interactions of a customer with a purchase incentive program via an additional dedicated web site (along with emails or SMS notifications), may be considered as adding further complexity to the digital life of the consumer. This may lead to a decrease in the interest of the customer for the purchase incentive program.

There is therefore a need for using common digital life tools as a new channel to perform management of purchase incentive programs, such as gift cards and loyalty programs.

### SUMMARY

The present disclosure relates to the field of management of purchase incentive programs; and more particularly to the usage of social networks as a new channel to perform management of gift cards and loyalty programs.

According to a first aspect, the present disclosure provides a method for managing a purchase incentive program using social networks. For doing so, the method receives, at a customer management server, a purchase incentive program management request. The purchase incentive program management request is generated by at least one interaction of a customer with a social network. The method processes, at the customer management server, the purchase incentive program management request, in relation with a profile of the customer. The processing includes at least one of: creating the profile of the customer, based on data from the purchase incentive program management request. Updating the profile of the customer, based on data from the purchase incentive program management request. Extracting information from the profile of the customer, based on data from the purchase incentive program management request; and sending a purchase incentive program management response, containing the information extracted from the profile of the customer.

According to another aspect, the present disclosure provides a system for managing a purchase incentive program using social networks. For doing so, the system comprises a communication entity, for receiving a purchase incentive program management request. The purchase incentive program management request is generated by at least one interaction of a customer with a social network. The system also comprises a customer's profile management entity, for processing the purchase incentive program management request in relation with a profile of the customer. The processing includes at least one of: creating the profile of the customer, based on data from the purchase incentive program management request. Updating the profile of the customer, based on data from the purchase incentive program management request. Extracting information from the profile of the customer, based on data from the purchase incentive program management request; and sending, via the communication entity, a purchase incentive program management response containing the information extracted from the profile of the customer.

According to another aspect of the present disclosure, the purchase incentive program consists of a gift card program, or a loyalty program.

According to another aspect of the present disclosure, the purchase incentive program management request consists of a purchase incentive program registration request, generated by at least one interaction of the customer with the social network.

According to another aspect of the present disclosure, the purchase incentive program management request consists of a purchase incentive program balance request, generated by at least one interaction of the customer with the social network.

According to another aspect of the present disclosure, the purchase incentive program management request consists of a social network profile update request.

According to another aspect of the present disclosure, the profile of the customer is processed to generate a targeted promotion, in relation to the purchase incentive program. The processing comprises an analysis of the social network profile information.

The foregoing and other features of the present method and system will become more apparent upon reading of the following non-restrictive description of examples of implementation thereof, given by way of illustration only with reference to the accompanying drawings.

### BRIEF DESCRIPTION OF THE DRAWINGS

In the appended drawings:

FIG. 1 illustrates a system for managing a purchase incentive program, according to a non-restrictive illustrative embodiment;

FIG. 2 illustrates a system for managing a purchase inventive program through a social network, according to a non-restrictive illustrative embodiment;

FIGS. 3a and 3b illustrate a method for managing a purchase incentive program through a social network, according to a non-restrictive illustrative embodiment;

FIG. 4 illustrate a customer's profile, according to a non-restrictive illustrative embodiment.

### DETAILED DESCRIPTION

The present disclosure relates to the field of management of purchase incentive programs; and more particularly to the usage of social networks as a new channel to perform management of gift cards and loyalty programs.

The following terminology is used throughout the present disclosure.

Purchase incentive program: an incentive program to encourage customers to purchase various types of products and services from specific merchant(s). Purchase incentive programs include gift cards and loyalty programs.

Gift card: a card offered as a gift to a person. The card allows this person to spend a specific amount of money, to buy products and services from a pre-defined list of merchant(s). The objective is to encourage a customer to buy from the merchant(s). The gift card contains a balance, which represents the amount of money which can be spent. The gift card is created with a specific amount of money, which represents the initial balance. When purchasing with the gift card, the amount of the purchase is deducted from the balance. The balance may be credited with an additional amount of money, during the existence of the gift card.

Prepaid card: a card bought from an entity for spending a specific amount of money to buy products and services from a predefined list of merchant(s). The prepaid card contains a balance, which represents the amount of money which can be spent. The perpaid card is created with an initial amount of money, which represents the initial balance. When purchasing with the prepaid card, the amount of the purchase is deducted from the balance. The balance may be credited with an additional amount of money, during the existence of the prepaid card.

Promotion card: a card similar to the prepaid card, and being related to a promotion from a merchant or list of merchants.

Loyalty program: a program in relation to one or a selected number of merchants; wherein buying products or services from the merchants(s) provides advantages (monetary or others). The objective is to develop the loyalty of a customer to the merchant(s). The loyalty program generally contains a balance, which represents an amount of money which can be spent. Upon buying from the merchant(s), the balance is credited with a specific amount of money (as a loyalty gift). The balance can be used for example to (partially) pay the amount of a purchase from the merchant(s).

Terminal: a computing device with communication means. The communications means allows the terminal to exchange information with other entities via a communication network. Examples of communication networks include cellular networks, fixed broadband networks, private communication networks belonging to a company. Examples of terminals include: Banking Machine, cash registers, computers, tablets, mobile phones, etc.

Social network: a digital network for digitally connecting and/or linking individuals. Examples of social networks include Facebook, Google+, Foursquare, Gowalla, Yelp.

Social network terminal: a terminal giving access to a social network. The interactions of a user with the social network are performed via a web browser or a dedicated software program, running on the terminal. Social network terminals include computers, mobile devices (mobile phones, tablets). The social network content is hosted on remote servers, which are accessed via the communication means of the terminal. In general, the terminal is not solely dedicated to interactions with a social network (other tasks may be performed with the terminal; for instance web browsing, messaging, video streaming, gaming).

Purchase transaction: the act of buying a product or a service from a merchant. The transaction may take place at the physical premises of the merchant. Alternatively, the transaction may take place via an electronic commerce web site operated by or on behalf of the merchant.

Purchase transaction terminal: a terminal used to perform the purchase transaction, including the payment of the purchase transaction. The purchase transaction terminal at the physical premises of a merchant consists in a dedicated payment system (e.g. a cash register, with for example a credit card interface). Alternatively, the purchase terminal is a personal terminal owned by a person performing an electronic commerce transaction (e.g. a computer or a mobile phone). In both cases, the purchase transaction terminal uses its communication means to register the purchase transaction (for instance the customer identification, the product purchased, the amount spent) with a customer management server (to be further defined in the following).

Gift card transaction: the act of activating, using the balance of a gift card to pay for a purchase transaction, and gift card recharging.

Gift card transaction terminal: a terminal to perform the gift card transaction. Generally the same terminal as the purchase transaction terminal used for the corresponding purchase transaction. The gift card transaction terminal uses its communication means to register the gift card transaction (for instance the customer identification, the amount of money used from the balance, the corresponding purchase transaction) with a customer management server (to be further defined in the following).

Loyalty program transaction/loyalty program transaction terminal: similar to the gift card transaction/gift card transaction terminal. However, loyalty program transactions include both credit transactions (the corresponding purchase transaction generates credits to the balance) and debit transactions (the corresponding purchase transaction is paid with the balance).

Gift card/loyalty program management terminal: a terminal to perform the management of a gift card/loyalty program. For instance, registration of the gift card/loyalty program, and interrogation of the balance of the gift card/loyalty program. The management terminal is usually operated by the merchant or list of merchants issuing the gift card /loyalty program, or a sub-contractor thereof.

Customer's profile: a profile containing multiple data relative to a specific customer. The customer's profile contains customer information, including demographic information relative to the customer. The customer's profile also contains purchase transactions information. And the customer's profile contains gift card/loyalty program information. Details about the data present in a customer's profile will be further disclosed later in the description.

Customer management server: a centralized server to manage the customer's profiles of a large number of customers. For this purpose, the customer management server communicates with various terminals, including: purchase transaction terminals, gift card/loyalty program transaction terminals, targeted promotion terminals (to be further defined in the following), social network terminals.

Targeted promotion terminal: a terminal for receiving a targeted promotion in relation to a gift card/loyalty program. The targeted promotion is generated by the customer management server, and sent to the targeted promotion terminal (e.g. a mobile phone or a computer belonging to a customer).

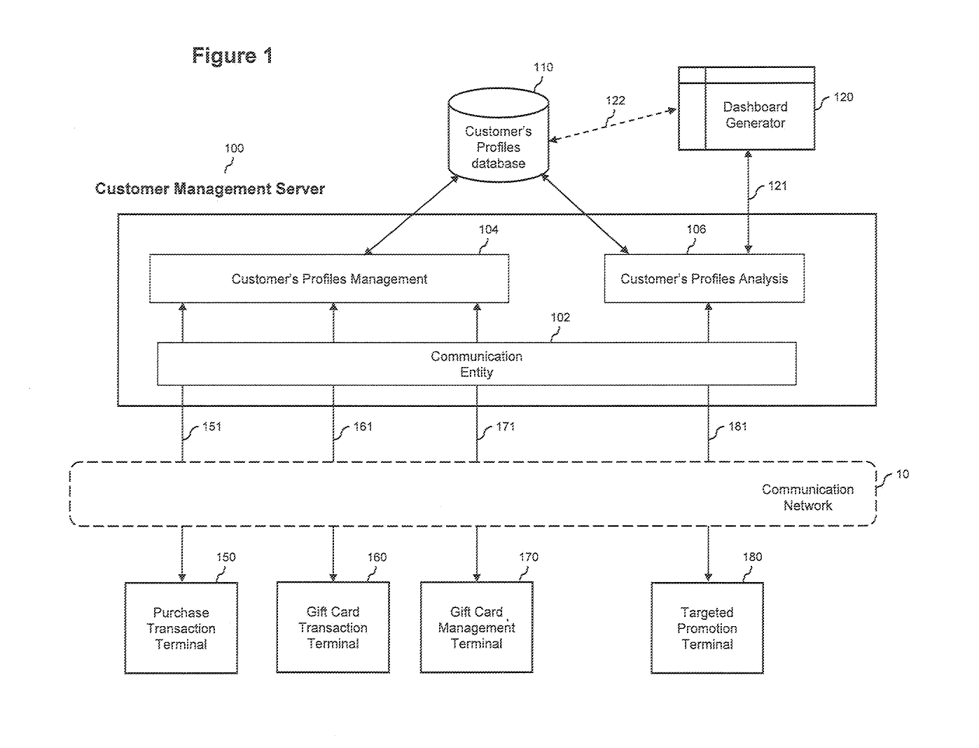

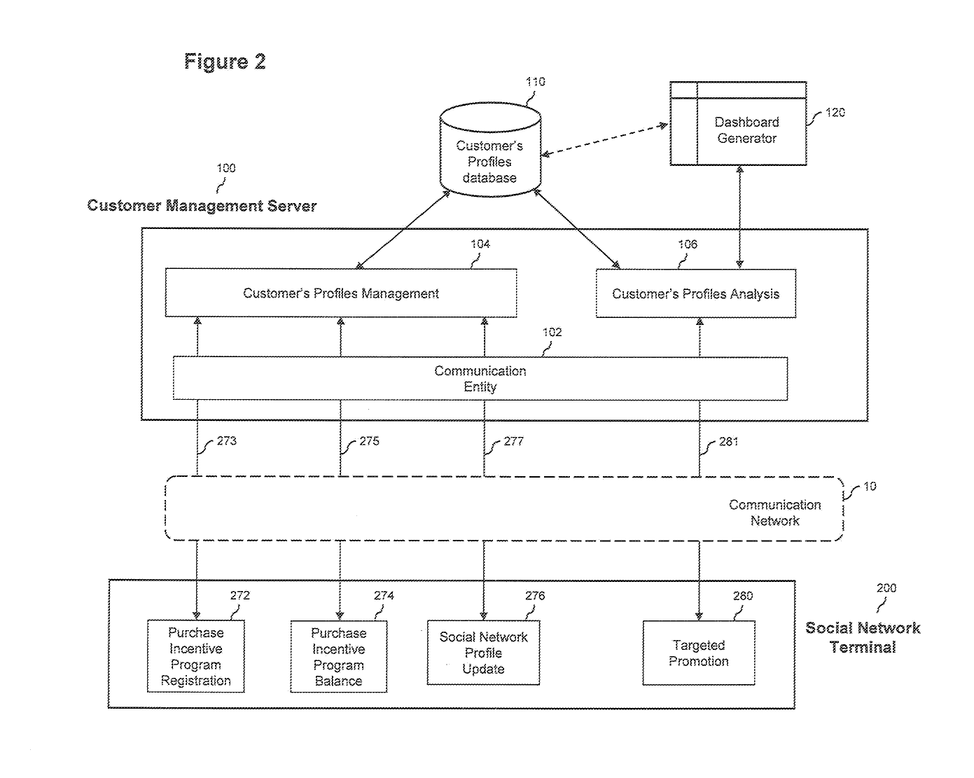

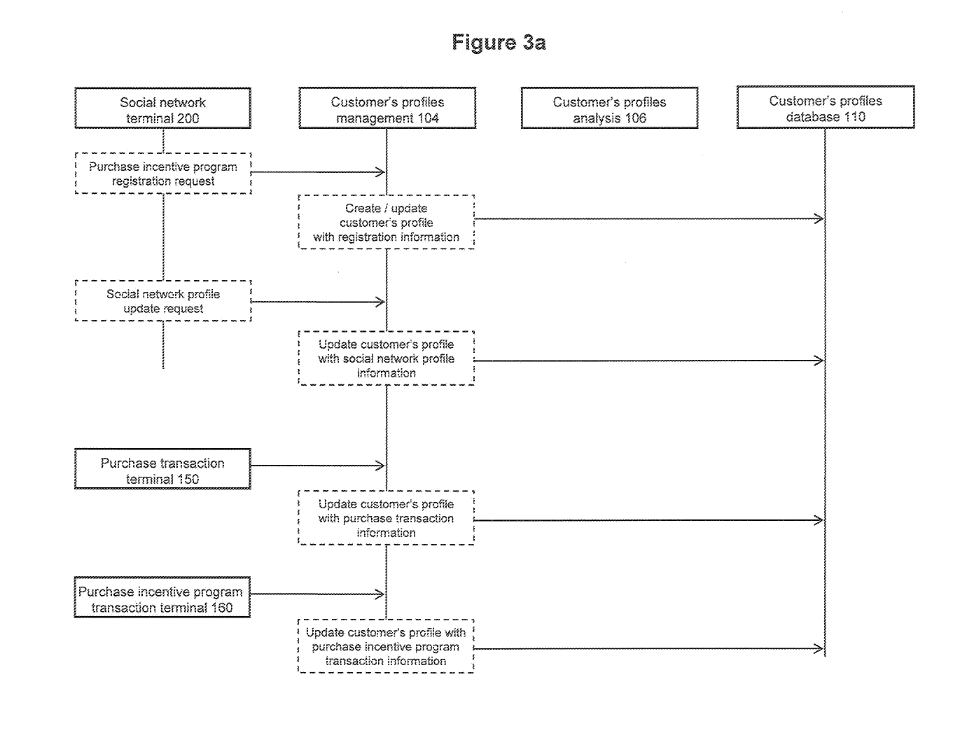

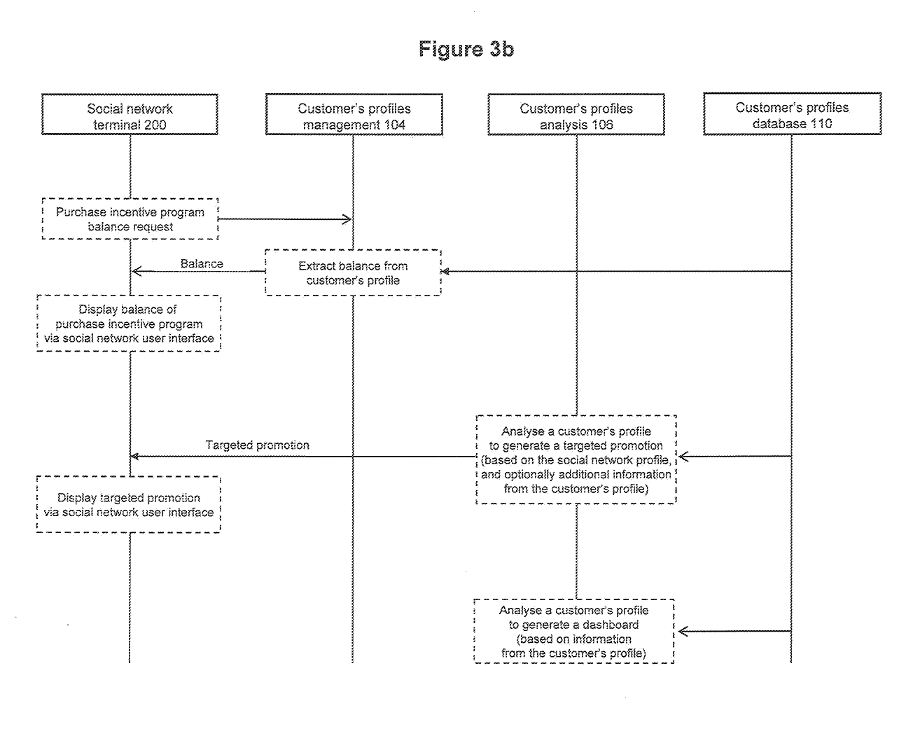

FIG. 1 represents a system for managing a purchase incentive program; FIGS. 3a and 3b, and FIG. 2 respectively represent a method and system for managing a purchase incentive program through a social network; wherein the purchase incentive program consists of a gift card. A gift card constitutes an example of a purchase incentive program. The present method and system applies to various types of purchase incentive programs, including gift card and loyalty programs. The following description details the present method and system in the context of a gift card, for illustration purposes only and should not be limited to gift card but interpreted to equally apply to gift cards and loyalty programs.

Referring now to FIG. 1, a system for managing a purchase incentive program will be described.

In FIG. 1, generic functionalities of a system for managing a purchase incentive program are represented. FIG. 2 will illustrate the same system, with additional functionalities to operate in the context of a social network.

The system illustrated in FIG. 1 comprises a customer management server 100. The customer management server 100 includes functionalities for managing customers of various types of products and services, offered by one or several merchants. In one embodiment of the present method and system, the management of a purchase incentive program constitutes one functionality among those provided by the customer manager server 100. In an alternative embodiment of the present method and system, the management of a purchase incentive program constitutes the only functionality provided by the customer manager server 100.

The customer management server 100 comprises a communication entity 102, for communicating with external entities via a communication network 10. Examples of communication networks 10 include mobile networks, fixed broadband networks, and private corporate networks. Four external entities communicating with the customer management server 100 are represented in FIG. 1: a purchase transaction terminal 150, a gift card transaction terminal 160, a gift card management terminal 170, and a targeted promotion terminal 180. However, more or less external entities could be used, and/or some of the external entities could be grouped together or subdivided. The communication entity 102 receives requests from the external entities; and sends responses to these requests when appropriate. The communication entity 102 also sends notifications to the external entities, when appropriate.

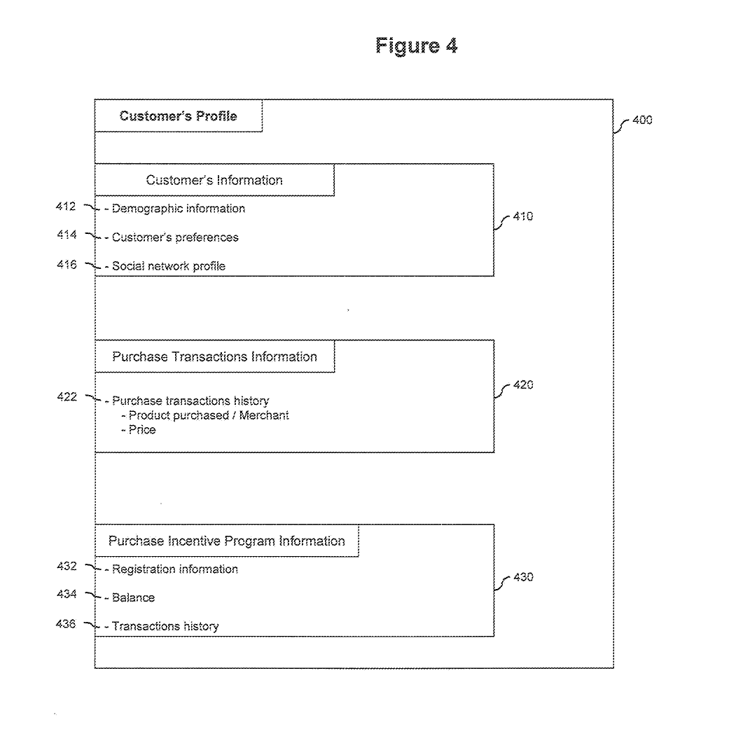

The customer management server 100 also comprises a customer's profiles management entity 104. Each customer managed by the customer management server 100 has a corresponding customer's profile, with specific information related to this customer. A customer's profile contains various types of data, including for instance: customer information, purchase transactions information, and gift card information; as will be illustrated later in the description in relation to FIG. 4.

The customer's profiles management entity 104 processes the requests received by the communication entity, updates the customer's profile of the customer referenced by a specific request, and generates a response to the request when appropriate. The response is sent by the communication entity 102 to the requesting external entity, for instance the gift card management terminal.

In general, a customer's profiles data base 110 is used for permanent storage of the customer's profiles. The customer's profiles management entity 104 updates the customer's profiles permanently stored in the customer's profiles data base 110. An update occurs when the processing of a request, by the customer's profiles management entity 104, requires an update to a customer's profile. Also, when the customer's profiles management entity 104 processes a request related to a specific customer, the corresponding customer's profile is retrieved from the customer's profiles database 110.

The communication entity 102 receives purchase incentive program management requests from a management terminal (for instance the gift card management terminal 170). The customer's profiles management entity 104 processes a purchase incentive program management request in relation with the profile of the customer referenced in the request. For this purpose, the customer's profile may be retrieved from the customer's profiles database 110.

The purchase incentive program management requests include registration requests. If no profile already exists for the customer in question, the profile of the customer is created, based on the data from the registration request to the purchase incentive program. If a profile already exists for the customer in question, the profile of the customer is updated, based on the data from the registration request (to the purchase incentive program). The created/updated customer's profile may further be stored in the customer's profiles database 110.

The customer's profile may be created via the registration request, in which case it is initialized with the data from the registration request. Alternatively, the customer's profile may be created via other means. In this case, the data from the registration request are used to populate a subsection of the customer's profile, dedicated to the purchase incentive program. The data from the registration request may include: an identification of the customer (for example: name, address, email address, phone number etc.), and an identification of the purchase incentive program (optionally including a list of the merchants affiliated with the purchase incentive program or a reference indicative of the corresponding purchase incentive program).

The purchase incentive program management requests include information requests. The requested information (related to the purchase incentive program) is extracted from the profile of the customer, based on data from the information request. A response containing the information extracted from the profile of the customer is sent by the communication entity 102 to the management terminal (for instance the gift card management terminal 170). The information requests include balance requests, which will be further detailed later in the description, in relation to FIG. 2.

FIG. 1 illustrates the aforementioned interactions 171, between a gift card management terminal 170 (as an exemplary illustration of a management terminal for a program incentive program) and the customer's profiles management entity 104, via the communication entity 102. FIG. 2 will further illustrate these interactions 171 in the context of a social network.

The communication entity 102 also receives purchase incentive program transaction notifications from a transaction terminal (for instance the gift card transaction terminal 160). The customer's profiles management entity 104 processes a purchase incentive program transaction notification in relation with the profile of the customer referenced in the notification. For this purpose, the customer's profile may be retrieved from the customer's profiles database 110. The profile of the customer is updated, based on the data from the notification (for instance the customer identification, the amount of money used from the balance, the corresponding purchase transaction). The update consists in updating the balance of the purchase incentive program, based on data from the notification. The update also consists in updating a transactions history of the purchase incentive program, based on data from the notification. The updated customer's profile may further be stored in the customer's profiles database 110. A response to the notification may also be sent by the communication entity 102 to the transaction terminal (for instance the gift card transaction terminal 160).

FIG. 1 illustrates the aforementioned interactions 161, between a gift card transaction terminal 160 (as an exemplary illustration of a transaction terminal for a program incentive program) and the customer's profiles management entity 104, via the communication entity 102.

The communication entity 102 also receives purchase transaction notifications from a purchase transaction terminal 150. The customer's profiles management entity 104 processes a purchase transaction notification in relation with the profile of the customer referenced in the notification. For this purpose, the customer's profile may be retrieved from the customer's profiles database 110. The profile of the customer is updated, based on the data from the notification. The update consists in updating a purchase transactions history, based on data from the notification (for instance the customer identification, the product purchased, the amount spent). The updated customer's profile may further be stored in the customer's profiles database 110. A response to the notification may also be sent by the communication entity 102 to the purchase transaction terminal 150.

FIG. 1 illustrates the aforementioned interactions 151, between a purchase transaction terminal 150 and the customer's profiles management entity 104, via the communication entity 102.

In some cases, the purchase transaction is related to a purchase incentive program transaction. It occurs when the product or service purchased is at least partially paid for with an amount of money from the balance of the purchase incentive program. In other cases, an independent purchase transaction is performed (the balance of the purchase incentive program is not used). The information related to this independent transaction is used to enrich the profile of the related customer (specifically the purchase transactions history).

The customer management server 100 comprises a customer's profiles analysis entity 106, for analyzing the profiles of the customers. In one embodiment, the customer's profiles analysis entity 106 processes the profile of a customer, to generate a targeted promotion in relation to the purchase incentive program. For this purpose, the customer's profile may be retrieved from the customer's profiles database 110. The information from the customer's profile taken into consideration for the analysis will be further detailed later in the description, in relation to FIG. 2. The targeted promotion is sent by the communication entity 102 to a targeted promotion terminal 180 owned by the customer (e.g. a mobile phone or a computer belonging to the customer). A response to the targeted promotion may be sent by the targeted promotion terminal 180 to the communication entity 102 (e.g. an indication of the interest of the customer for the promotion, and the customer's profile may be further enriched with this indication by the customer's profiles analysis entity 106).

FIG. 1 illustrates the aforementioned interactions 181, between the customer's profiles analysis entity 106 and a targeted promotion terminal 180, via the communication entity 102.

In another embodiment, the customer's profiles analysis entity 106 processes the profile of a customer (or a plurality of profiles of customers), to generate a dashboard in relation to the purchase incentive program. For this purpose, the customer's profile may be retrieved from the customer's profiles database 110. The information from the customer's profile taken into consideration for the analysis will be further detailed later in the description, in relation to FIG. 2. The generation of the dashboards is managed by a dashboard generator 120, which communicates 121 with the customer's profiles analysis entity 106. The dashboard generator 120 is represented as an independent entity in FIG. 1, but may also be a sub-entity of the customer management server 100. The dashboard generator 120 comprises a user interface, allowing an end user of the present system to request the generation of a specific dashboard. For this purpose, the end user specifies parameters related to the requested dashboard. These parameters are transmitted 121 to the customer's profiles analysis entity 106. Based on these parameters, one or a plurality of customer's profiles is analyzed. A corresponding dashboard is generated based on this analysis, and transmitted 121 by the customer's profiles analysis entity 106 to the dashboard generator 120. The dashboard 120 is then displayed on the user interface of the dashboard generator 120. Alternatively, the dashboard generator 120 may communicate directly 122 with the customer's profiles database 110, to extract customer's profiles. In this case, the dashboard generator 120 also has analysis capabilities, to process the customer's profiles and generate the dashboards.

Referring now to FIGS. 2, 3a and 3b, concurrently, a method and system for managing a purchase incentive program through a social network will be described.

The customer management server 100 represented in FIG. 2 is similar to the customer management server 100 represented in FIG. 1. However, the functionalities of the customer's profiles management entity 104 and the customer's profiles analysis entity 106 are adapted to operate in the context of a social network. The purchase transaction terminal 150 and the gift card transaction terminal 160 of FIG. 1 are not represented in FIG. 2 for simplification purposes. The interactions of these two terminals with the customer management server 100 are not affected in the context of a social network.

The social network terminal 200 in FIG. 2 integrates functionalities similar to those of the gift card management terminal 170 and the targeted promotion terminal 180 represented in FIG. 1. The social network terminal 200 integrates three functionalities related to the management of a purchase incentive program: purchase incentive program registration 272, purchase incentive program balance 274, and social network profile update 276. The social network terminal 200 also integrates a targeted promotion functionality 280. As mentioned previously, the purchase incentive program may consist of a gift card program, or a loyalty program.

As mentioned earlier in the description, the social network terminal 200 is a terminal giving access to a social network. The interactions of a customer with the social network are performed via a web browser or a dedicated software program, running on the terminal. A customer generally accesses the social network via different terminals, based on its current location and the current circumstances. For instance, a customer may access the social network via a computer or a tablet at home, via a computer at work, and via a mobile phone while on the move. Thus, the social network terminal 200 is a generic term, including any terminal used by the customer to interact with the social network.

The functionalities related to the purchase incentive program (272, 274, 276, and 280) are integrated in the social network execution environment. For instance, the customer is proposed to add a plug-in and the required module(s), such as for example Application Programming Interface (API) and/or Web Services, to the social network execution environment. This plug-in and required module(s) integrate the functionalities (272, 274, 276, and 280) of the purchase incentive program. The plug-in and the required module(s) usually consist of a software program executed in the social network execution environment. The plug-in and the required module(s) also have a user interface integrated to the social network user interface. Thus, the functionalities (272, 274, 276, and 280) of the purchase incentive program are directly accessed via the social network user interface.

The advantage of integrating the functionalities (272, 274, 276, and 280) of the purchase incentive program in a social network environment lies in the fact that end users spend more and more time interacting with social networks. End users increasingly tend to consider their favorite social network has their preferred interface to Internet services in general. As a matter of fact, social networks have the capability to integrate an ever growing set of functionalities, via the usage of plug-ins to integrate these functionalities to the social network environment. Thus, end users have a preference for accessing Internet services via the social network environment, rather than via a dedicated web site or a dedicated software program. For instance, the credentials used to protect the access to a social network may be used for directly accessing an Internet service integrated to the social network environment (for instance, the purchase incentive program management). This makes the end user experience faster and easier, in comparison to a dedicated web site, where the end user must provide its credentials before using the Internet service in question.

The gift card management terminal 170 represented in FIG. 1 represents the traditional way of managing a purchase incentive program, without integrating the management functionalities with a social network. The management functionalities are usually provided via a dedicated web site, accessed via the terminal 170. The dedicated web site may be dedicated to the management of the purchase incentive program exclusively. Alternatively, the dedicated web site may be the web site of a merchant offering the purchase incentive program, with a sub-section of the web site dedicated to the management of the program incentive program. Part of the management functionalities may also be provided by a terminal at the premises of a merchant involved in the purchase incentive program, for instance via a call center or directly at the premises of the merchant. Thus, for customers spending a significant amount of time interacting with social networks, integrating the management of the purchase incentive program to the social network makes this management easier, faster, and more integrated with their everyday social network activities (by comparison with the management described in relation to FIG. 1). By combining the management of the purchase incentive programs with social networks, consumers can additionally make better usage of their purchase incentive programs and gift cards.

The management of the purchase incentive program through a social network, as represented in FIG. 2, operates as follows. The communication entity 102 receives a purchase incentive program management request from the social network terminal 200. The purchase incentive program management request is generated by at least one interaction of the customer with the social network on the social network terminal 200. The purchase incentive program management request is processed by the customer's profiles management entity 104, in relation with the profile of the customer. Based on the type of the request, the processing includes at least one of the following. Creating the profile of the customer, based on data from the purchase incentive program management request. Updating the profile of the customer, based on data from the purchase incentive program management request. Extracting information from the profile of the customer, based on data from the purchase incentive program management request. And sending a purchase incentive program management response, containing the information extracted from the profile of the customer by the customer's profiles management entity; from the communication entity 102 to the social network terminal 200.

In one embodiment, the purchase incentive program management request consists of a purchase incentive program registration request, sent by the purchase incentive program registration functionality 272 to the communication entity 102. The purchase incentive program registration request is processed by the customer's profiles management entity 104 in a similar way as previously described in relation to FIG. 1. The purchase incentive program management request is generated by the customer, via the social network user interface on the social network terminal 200.

FIG. 2 illustrates the aforementioned interactions 273, between a purchase incentive program registration functionality 272 of a social network terminal 200 and the customer's profiles management entity 104, via the communication entity 102.

In another embodiment, the purchase incentive program management request consists of a purchase incentive program balance request, sent by the purchase incentive program balance functionality 274 to the communication entity 102. The purchase incentive program balance request is processed by the customer's profiles management entity 104. The processing consists in extracting the balance of the purchase incentive program from the customer's profile of the targeted customer. A response containing the balance is sent by the communication entity 102 to the purchase incentive program balance functionality 274. The balance is displayed to the customer, via the social network user interface on the social network terminal 200. The purchase incentive program balance request is generated by the customer, via the social network user interface on the social network terminal 200.

FIG. 2 illustrates the aforementioned interactions 275, between a purchase incentive program balance functionality 274 of a social network terminal 200 and the customer's profiles management entity 104, via the communication entity 102.

In another embodiment, the purchase incentive program management request consists of a social network profile update request, sent by the social network profile update functionality 276 to the communication entity 102. The social network profile update request is processed by the customer's profiles management entity 104. The processing consists in updating the profile of the customer with social network profile information, based on data from the social network profile update request. Optionally, a response may be sent by the communication entity 102 to the social network profile update functionality 276. The social network profile information is representative of interactions of the customer with the social network. The interactions are relative to any type of functionalities and services offered by the social network. This type of information (related to the interactions) is usually gathered by the social network, since the gathering is inherent to the operations of a social network. One objective of a social network is to generate a social network profile of its users, representative of their preferences and habits. Sharing this social network profile (or at least a portion of it) with the customer management server 100, via the aforementioned mechanism, is usually based on an opt-in decision by the customer.

FIG. 2 illustrates the aforementioned interactions 277, between a social network profile update functionality 276 of a social network terminal 200 and the customer's profiles management entity 104, via the communication entity 102.

As already mentioned in relation to FIG. 1, the customer's profiles analysis entity 106 processes the profile of the customer, to generate a targeted promotion in relation to the purchase incentive program.

In one embodiment, the processing comprises performing an analysis of the social network profile information of the customer's profile.

In another embodiment, the processing comprises performing an analysis of the combination of at least one of: the social network profile information, the balance of the purchase incentive program, and the transactions history of the purchase incentive program (as defined in relation to FIG. 1).

In another embodiment, the processing comprises performing an analysis of the combination of at least one of: the social network profile information, the balance of the purchase incentive program, the transactions history of the purchase incentive program, and the purchase transactions history (as defined in relation to FIG. 1).

The combination of information used to perform the processing is dependant on which information is present in the customer's profile. Some information may not be gathered by a specific embodiment of the customer management server 100 (for example, the purchase transactions history may not be present). Also, more information taken into consideration means a more complex algorithm to process the information (more costly to design), with more processing power (and possibly time) required. One shall keep in mind that a customer management server 100 may store thousands to hundreds of thousands customer profiles. And the processing for analysing the selected information in the profiles, to generate the targeted offering, is potentially applied to all the customer profiles.

The following represents examples of information from the customer's profile which may be taken into consideration, to generate the targeted promotion. The social network profile information indicates that the customer is interested in music and multimedia equipment. The balance of the purchase incentive program is higher than a pre-defined threshold. The transactions history of the purchase incentive program indicates that the customer has made not transaction (related to the purchase incentive program) since a pre-defined number of weeks. The purchase transactions history indicates that the customer has not purchased on-line music since a pre-defined number of days. The resulting targeted promotion may consist in encouraging the customer to buy on-line music from a merchant engaged in the purchase incentive program, using money from the balance of the purchase incentive program to get a discount.

The targeted promotion is sent by the communication entity 102 to the targeted promotion functionality 280. A response to the targeted promotion may be sent by the targeted promotion functionality 280 to the communication entity 102 (e.g. an indication of the interest of the customer for the promotion, and the customer's profile may be further enriched with this indication by the customer's profiles analysis entity 106). The targeted promotion is displayed to the customer, via the social network user interface on the social network terminal 200. If the targeted promotion is directed to a merchant whose products and services are offered via the social network, the targeted promotion can be used by the customer directly via the social network user interface. This kind of integration, of the purchase incentive program and the offerings of the related merchants, with the social network, usually guarantees a better success rate of a targeted promotion.

FIG. 2 illustrates the aforementioned interactions 281, between a targeted promotion functionality 280 of a social network terminal 200 and the customer's profiles analysis entity 106, via the communication entity 102.

In an alternative embodiment, the social network may not be used to present the targeted promotion to the customer. Instead, a more traditional media, such as an e-mail or a SMS (Short Message Service), may be used for this purpose.

As already mentioned in relation to FIG. 1, in another embodiment, the customer's profiles analysis entity 106 processes the profile of a customer (or a plurality of profiles of customers), to generate a dashboard in relation to the purchase incentive program. The processing comprises performing an analysis of the combination of at least one of: the social network profile information, the balance of the purchase incentive program, the transactions history of the purchase incentive program, and the purchase transactions history.

The following represents examples of information from the customer's profile which may be taken into consideration, to generate a dashboard. The evolution of the balance of the purchase incentive program over a period of time, the evolution of the number of transactions related to the purchase incentive program over a period of time (based on the transactions history of the purchase incentive program), the evolution of the number of purchase transactions and the amount of money spent per transaction over a period of time (based on the purchase transactions history). Alternatively, a dashboard may show the correlation of the social network profile with the transactions history of the purchase incentive program. For this purpose, each transaction related to the purchase incentive program is associated with at least one area of interest of the customer identified in the social network profile. Then, the evolution of the number of transactions per domain of interest is represented over a period of time.

Referring now to FIG. 4, a customer's profile will be described.

FIG. 4 represents an exemplary embodiment of a customer's profile 400, comprising the information described in relation to FIGS. 1 and 2.

The customer's profile 400 includes a first subsection, the customer's information 410. This subsection includes the information directly related to the customer. Demographic information 412 is included. This type of information identifies a specific customer, via for example its name, address, phone number, gender, date of birth. This type of information may be provided via the purchase incentive program registration functionality 272 represented in FIG. 2. This type of information may also be provided by any other appropriate means, not directly related to the present method and system. Then customer's preferences 414 are included. These customer's preferences may be generated, by analyzing the purchase transactions history. Then, a social network profile 416 is included. The social network profile 416 is provided via the social network profile update functionality 276 represented in FIG. 2.

The customer's profile 400 includes a second subsection, the purchase transactions information 420. This subsection includes the information directly related to the purchase transactions. The purchase transactions history 422 is included. Each purchase transaction item of the history may contain the product purchased, the merchant from which the product was purchased, and its price (as represented in FIG. 4). The purchase transactions history 422 is provided via a purchase transaction terminal 150 represented in FIG. 1.

The customer's profile 400 includes a third subsection, the purchase incentive program information 420. This subsection includes the information directly related to the purchase incentive program. The registration information 432 is included. The registration information 432 is provided via the purchase incentive program registration functionality 272 represented in FIG. 2. The balance 434 is included. The balance 434 is provided via a purchase incentive program transaction terminal (for example, the gift card transaction terminal 160 represented in FIG. 1). The transactions history 436 is included. The transactions history 436 is provided via a purchase incentive program transaction terminal (for example, the gift card transaction terminal 160 represented in FIG. 1).

Coming back to FIG. 2, the customer's profiles management entity 104, the customer's profiles analysis entity 106, and the communication entity 102, are respectively composed of dedicated software programs executed on dedicated computers. Alternatively, dedicated software programs corresponding to any combinations of the customer's profiles management entity 104, the customer's profiles analysis entity 106, and the communication entity 102, may be executed on the same computer. The dashboard generator 120 is also composed of dedicated software programs executed on a computer.

Although the present disclosure has been described in the foregoing description by way of illustrative embodiments thereof, these embodiments can be modified at will, within the scope of the appended claims without departing from the spirit and nature of the appended claims.

What is claimed is:

1. A method for managing a purchase incentive program using social networks, the method comprising:
receiving at a customer management server a purchase incentive program management request, the purchase incentive program management request being generated by at least one interaction of a customer with a social network; and
processing at the customer management server the purchase incentive program management request in relation with a profile of the customer, the processing including at least one of:
creating the profile of the customer based on data from the purchase incentive program management request;
updating the profile of the customer based on data from the purchase incentive program management request; and
extracting information from the profile of the customer based on data from the purchase incentive program management request; and sending a purchase incentive program management response containing the information extracted from the profile of the customer.

2. The method of claim 1, wherein the purchase incentive program consists of a gift card program, or a loyalty program.

3. The method of claim 1, wherein the purchase incentive program management request consists of a purchase incentive program registration request generated by at least one interaction of the customer with the social network; and processing the purchase incentive program registration request comprises one of:
creating the profile of the customer with purchase incentive program information based on data from the purchase incentive program registration request; and
updating the profile of the customer with purchase incentive program information based on data from the purchase incentive program registration request;
wherein the purchase incentive program information comprises registration information for the purchase incentive program and a balance of the purchase incentive program.

4. The method of claim 3, wherein the purchase incentive program management request consists of a purchase incentive program balance request generated by at least one interaction of the customer with the social network; and processing the purchase incentive program balance request comprises:
extracting the balance of the purchase incentive program from the profile of the customer; and sending a purchase incentive program balance response containing the balance of the purchase incentive program;
wherein the purchase incentive program balance in the purchase incentive program balance response is displayed to the customer via the social network.

5. The method of claim 4, wherein the purchase incentive program management request consists of a social network profile update request; and processing the social network profile update request comprises:
updating the profile of the customer with social network profile information based on data from the social network profile update request;
wherein the social network profile information is representative of interactions of the customer with the social network.

6. The method of claim 5 further comprising:
processing at the customer management server the profile of the customer to generate a targeted promotion in relation to the purchase incentive program, the processing comprising an analysis of the social network profile information.

7. The method of claim 6 further comprising:
receiving at the customer management server a purchase incentive program transaction notification; and
processing at the customer management server the purchase incentive program transaction notification to update the profile of the customer; the update of the profile of the customer consisting in at least one of:
updating the balance of the purchase incentive program based on data from the purchase incentive program transaction notification; and
updating a transactions history of the purchase incentive program based on data from the purchase incentive program transaction notification.

8. The method of claim 7; wherein processing the profile of the customer to generate a targeted promotion in relation to the purchase incentive program comprises an analysis of the combination of at least one of: the social network profile information, the balance of the purchase incentive program, and the transactions history of the purchase incentive program.

9. The method of claim 8 further comprising:
receiving at the customer management server a purchase transaction notification; and
processing at the customer management server the purchase transaction notification to update the profile of the customer; the update of the profile of the customer consisting in:
updating a purchase transactions history based on data from the purchase transaction notification;
wherein processing the profile of the customer to generate a targeted promotion in relation to the purchase incentive program comprises an analysis of the combination of at least one of: the social network profile information, the balance of the purchase incentive program, the transactions history of the purchase incentive program; and the purchase transactions history.

10. The method of claim 9 further comprising:
processing at the customer management server the profile of the customer to generate a dashboard, the processing comprising an analysis of the combination of at least one of: the social network profile information, the balance of the purchase incentive program, the transactions history of the purchase incentive program; and the purchase transactions history.

11. A system for managing a purchase incentive program using social networks, the system comprising:
a communication entity for receiving a purchase incentive program management request, the purchase incentive program management request being generated by at least one interaction of a customer with a social network;
a customer's profiles management entity for processing the purchase incentive program management request in relation with a profile of the customer, the processing including at least one of:
creating the profile of the customer based on data from the purchase incentive program management request;
updating the profile of the customer based on data from the purchase incentive program management request; and
extracting information from the profile of the customer based on data from the purchase incentive program management request; and sending via the communication entity a purchase incentive program management response containing the information extracted from the profile of the customer.

12. The system of claim 11, wherein the purchase incentive program consists of a gift card program, or a loyalty program.

13. The system of claim 11, wherein the purchase incentive program management request consists of a purchase incentive program registration request generated by at least one interaction of the customer with the social network; and processing the purchase incentive program registration request comprises one of:
creating the profile of the customer with purchase incentive program information based on data from the purchase incentive program registration request; and
updating the profile of the customer with purchase incentive program information based on data from the purchase incentive program registration request;
wherein the purchase incentive program information comprises registration information for the purchase incentive program and a balance of the purchase incentive program.

14. The system of claim 13, wherein the purchase incentive program management request consists of a purchase incentive program balance request generated by at least one interaction of the customer with the social network; and processing the purchase incentive program balance request comprises:
extracting the balance of the purchase incentive program from the profile of the customer; and sending via the communication entity a purchase incentive program balance response containing the balance of the purchase incentive program;
wherein the purchase incentive program balance in the purchase incentive program balance response is displayed to the customer via the social network.

15. The system of claim 14, wherein the purchase incentive program management request consists of a social network profile update request; and processing the social network profile update request comprises:
updating the profile of the customer with social network profile information based on data from the social network profile update request;
wherein the social network profile information is representative of interactions of the customer with the social network.

16. The system of claim 15 further comprising a customer's profiles analysis entity for processing the profile of the customer to generate a targeted promotion in relation to the purchase incentive program, the processing comprising performing an analysis of the social network profile information.

17. The system of claim 16 further comprising a social network terminal for:
generating the purchase incentive program registration request, the purchase incentive program balance request, and the social network profile update request;
sending the purchase incentive program registration request, the purchase incentive program balance request, and the social network profile update request;
receiving the purchase incentive program balance response and a targeted promotion notification containing the targeted promotion; and
displaying the purchase incentive program balance and the targeted promotion;
wherein the social network terminal allows interactions of the subscriber with the social network.

18. The system of claim 16 further comprising:
receiving at the communication entity a purchase incentive program transaction notification; and
processing at the customer's profiles management entity the purchase incentive program transaction notification to update the profile of the customer; the update of the profile of the customer consisting in at least one of:
updating the balance of the purchase incentive program based on data from the purchase incentive program transaction notification; and
updating a transactions history of the purchase incentive program based on data from the purchase incentive program transaction notification;
wherein processing of the profile of the customer by the customer's profiles analysis entity to generate a targeted promotion in relation to the purchase incentive program comprises performing an analysis of the combination of at least one of: the social network profile information, the balance of the purchase incentive program, and the transactions history of the purchase incentive program.

19. The method of claim 18 further comprising:
receiving at the communication entity a purchase transaction notification; and
processing at the customer's profiles management entity the purchase transaction notification to update the profile of the customer; the update of the profile of the customer consisting in:
updating a purchase transactions history based on data from the purchase transaction notification;
wherein processing of the profile of the customer by the customer's profiles analysis entity to generate a targeted promotion in relation to the purchase incentive program comprises performing an analysis of the combination of at least one: of the social network profile information, the balance of the purchase incentive program, the transactions history of the purchase incentive program; and the purchase transactions history.

20. The method of claim 19 further comprising:
processing the profile of the customer by the customer's profiles analysis entity to generate a dashboard, the processing comprising performing an analysis of the combination of at least one of: the social network profile information, the balance of the purchase incentive program, the transactions history of the purchase incentive program; and the purchase transactions history.
